(19) United States
(12) Patent Application Publication
(10) Pub. No.: US 2014/0234594 A1
(43) Pub. Date: Aug. 21, 2014

(54) DECORATIVE FILM FOR DISPLAY DEVICE AND PROTECTIVE PANEL

(71) Applicants: NISSHA PRINTING CO., LTD., Kyoto-shi, Kyoto (JP); SUN PARK CORPORATION, Sumida-ku, Tokyo (JP)

(72) Inventors: Tetsuya Ito, Sumida-ku (JP); Tomohisa Hosoya, Sumida-ku (JP)

(21) Appl. No.: 14/352,311

(22) PCT Filed: Oct. 19, 2012
(86) PCT No.: PCT/JP2012/077056

§ 371 Date: Apr. 16, 2014

(30) Foreign Application Priority Data
Oct. 20, 2011 (JP) 2011-230361
Mar. 30, 2012 (JP) PCT/JP2012/002248
Jul. 27, 2012 (JP) 2012-166762

(51) Int. Cl. G02F 1/1333

(52) U.S. Cl. CPC G02F 1/133308; G02F 2001/133331
USPC 428/203

(57) ABSTRACT

A decorative film that is arranged directly or indirectly on a display surface of a display device, and that includes a display region, which is a central part, having light transmissivity so that the display surface can be visually recognized from outside, and a decorative region, which is an outer peripheral part of the display region, for decorating the display surface; the decorative film including a base layer containing an insulating resin base material and arranged in the decorative region, a decorative pattern layer formed on a main surface of the base layer, and a light transmissive layer arranged in a space surrounded by the base layer and the decorative pattern layer in at least the display region.

### TECHNICAL FIELD

The present invention relates to a decorative film for a display device for adding decoration to a display surface of the display device, and a protective film using the same.

### BACKGROUND ART

A protective panel of a flat panel display of a liquid crystal display device in which a printing section is formed by printing on a transparent protective plate, and thereafter, a level difference of the printing section and the protective plate resulted from the printing is flattened with a photo-curing transparent resin is known (Patent Document 1, Patent Document 2).

### PRIOR ART DOCUMENTS

### Patent Documents

Patent Document 1: Japanese Patent Laid-Open Publication No. 2010-176111

Patent Document 2: Japanese Patent Laid-Open Publication No. 2008-83263

### DISCLOSURE OF THE INVENTION

### Problems to be Solved by the Invention

However, even with the conventional protective panel of Patent Document 1, involvement of air may occur at the display surface near the level difference of the printing section and the protective plate since the protective panel is formed by printing the photo-curing transparent resin on the protective plate. Even with the conventional protective panel of Patent Document 2 as well, the films 3, 6 that are not formed with an opening are arranged, and hence involvement of air may occur due to the level difference of the film and a metal vapor-deposited membrane 4, and a level difference of the film and a hiding layer 8 (decorative pattern layer of the invention of the present application).

It is an object of the present invention to provide a decorative film capable of suppressing the involvement of air at the display surface near the level difference of the printing section and the protective plate, and a protective panel using the same.

### Solutions to the Problems

A decorative film for a display device and a protective panel using the same according to the present invention relates to a decorative film that is directly or indirectly arranged on a display surface of the display device. The decorative film includes a display region, which is a central part of the decorative film, having light transmittivity through which the display surface is visually recognized from outside, and a decorative region, which is an outer peripheral part around the display region, for decorating the display surface. The decorative film includes a base layer containing an insulating resin base material and arranged in the decorative region, a decorative pattern layer formed on the base layer, and a light transmissive layer arranged in at least a space surrounded by the base layer and the decorative pattern layer in the display region.

In the present invention, the light transmissive layer may be arranged in an extended manner on a main surface on a side of the decorative pattern layer opposite to the base layer, or may be arranged in an extended manner on a main surface of the base layer on a side opposite to the decorative pattern layer. In the present invention, the transmittivity of the light transmissive layer preferably has a transmissivity of greater than or equal to 80% to maintain and enhance the visibility of the display.

In the present invention, the base layer may be a colorless layer or a colored layer.

In the present invention, the decorative pattern layer may be formed with a single layer or may be formed with multiple layers. The light transmissive layer desirably has a transmissivity of greater than or equal to 80%, and is desirably made from an acrylic compound. Furthermore, the light transmissive layer may be divided into a plurality of layers in a thickness direction, the respective hardness of the plurality of layers may be differed.

In the present invention, the decorative pattern layer may be arranged only on one main surface of the base layer or may be arranged on both main surfaces. If the decorative pattern layer is arranged on both main surfaces of the base layer, the properties of the decorative pattern layers may be the same or may be different from each other.

In the present invention, the decorative film may have an attachment layer made of an adhesion material or a sticky material arranged on at least one main surface. The decorative film may have a peeling sheet arranged on at least one main surface.

In the present invention, boundary surfaces of the base layer and the light transmissive layer are formed flush, and boundary surfaces of the decorative pattern layer and the light transmissive layer are formed flush in the cross-sectional view of the decorative film.

A protective panel for a display device according to the present invention includes a decorative film and a protective plate, where the decorative film is arranged between the display surface and the protective plate, or faces the display surface with the protective plate sandwiched in between.

In the present invention, the decorative film and the protective plate can be directly attached to each other by an adhesion material, a sticky material, an adhesion tape, or a sticky tape.

In the present invention, a hard coat film may be arranged on a side of the decorative film opposite to the surface attached with the protective plate.

### Effects of the Invention

In the present invention, the light transmissive layer is arranged in the openings of the base layer and the decorative pattern layer, so that the involvement of air at the display surface can be suppressed since the light transmissive layer is primarily not formed on the base layer at the display surface.

### BRIEF DESCRIPTION OF THE DRAWINGS

FIG. 1 is a front view showing a decorative film according to one embodiment of the present invention.

FIG. 2 is a cross-sectional view taken along line II-II of FIG. 1.

FIG. 3 is a front view showing one example of a display device to which the decorative film of FIG. 1 is attached.

FIG. 4 is a cross-sectional view showing a decorative film according to another embodiment of the present invention (view corresponding to FIG. 2).

FIG. 5 is a cross-sectional view showing a decorative film according to another further embodiment of the present invention (view corresponding to FIG. 2).

FIG. 6 is a cross-sectional view showing a decorative film according to still another further embodiment of the present invention (view corresponding to FIG. 2).

FIG. 7 is a cross-sectional view showing a state in which a protective panel using the decorative film according to the present invention is attached to a display device.

FIG. 8 is a step diagram showing one example of a manufacturing method of the protective panel for the display device according to the present invention (part 1).

FIG. 9 is a step diagram showing one example of the manufacturing method of the protective plate for the display device following FIG. 8 (part 2).

FIG. 10 is a step diagram showing one example of the manufacturing method of the protective plate for the display device following FIG. 9 (part 3).

FIG. 11A is a cross-sectional view showing another embodiment of the protective panel for the display device according to the present invention.

FIG. 11B is a cross-sectional view showing still another further embodiment of the protective panel for the display device according to the present invention.

FIG. 11C is a cross-sectional view showing still another further embodiment of the protective panel for the display device according to the present invention.

FIG. 11D is a cross-sectional view showing still another further embodiment of the protective panel for the display device according to the present invention.

FIG. 11E is a cross-sectional view showing still another further embodiment of the protective panel for the display device according to the present invention.

FIG. 11F is a cross-sectional view showing still another further embodiment of the protective panel for the display device according to the present invention.

FIG. 11G is a cross-sectional view showing still another further embodiment of the protective panel for the display device according to the present invention.

FIG. 11H is a cross-sectional view showing still another further embodiment of the protective panel for the display device according to the present invention.

FIG. 11J is a cross-sectional view showing still another further embodiment of the protective panel for the display device according to the present invention.

FIG. 11K is a cross-sectional view showing another further embodiment of the protective panel for the display device according to the present invention.

### BEST MODE FOR CARRYING OUT THE INVENTION

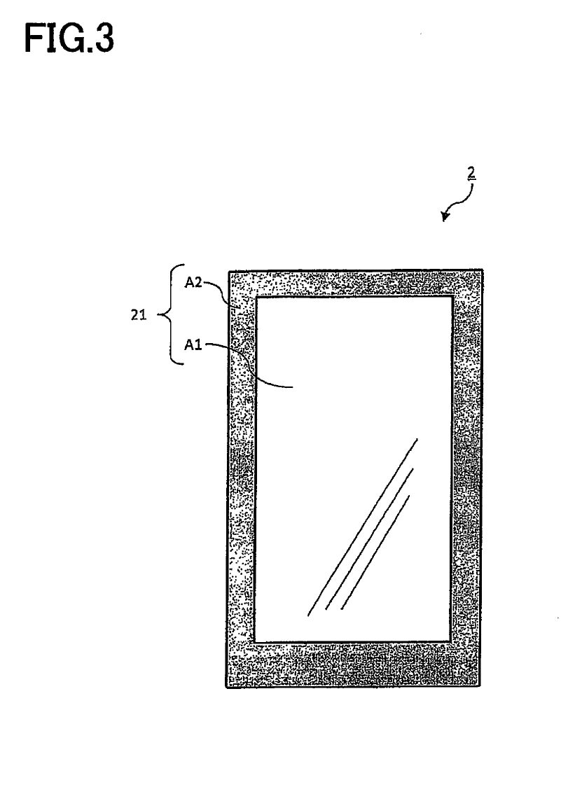

One embodiment of a decorative film and a protective panel according to the present invention will be hereinafter described based on the drawings. As shown in FIG. 3, a display device 2 includes a display surface 21, and the display surface 21 includes an image display region Al and a peripheral edge region (so-called frame region) A2. The image display region Al is a region for displaying an image, and the peripheral edge region A2 is a region including an accessory element such as a wiring pattern, and the like. A decorative film 1 of the present embodiment is a film for hiding the accessory element such as the wiring pattern, and the like arranged in the peripheral edge region A2 from the viewer, and at the same time, adding new decoration to the peripheral edge region A2.

The display device 2 applied with the decorative film 1 of the present embodiment may be a liquid crystal display device, a plasma display device, an organic EL display, or the like. If a touch panel, which is an in-plane contact type input device, is arranged in the display device 2, the display device 2 is a device including the touch panel. The display surface 21 of the display device 2 is a surface of a member element positioned on the outermost surface of the display device 2. Such member element includes a glass, a polarization plate, or other optical films.

A plate-like member having a thin thickness is generally referred to as a “film” and a plate-like member having a thick thickness is generally referred to as a “sheet”, but in the present specification, the concept of the term “film” also includes the general “sheet”. An attached state peelable by a human hand is referred to as “stick”, an attached state not peelable by a human hand is referred to as “adhere”, and a pasted state regardless of the state is referred to as “attach”.

<<Configuration of Decorative film>>

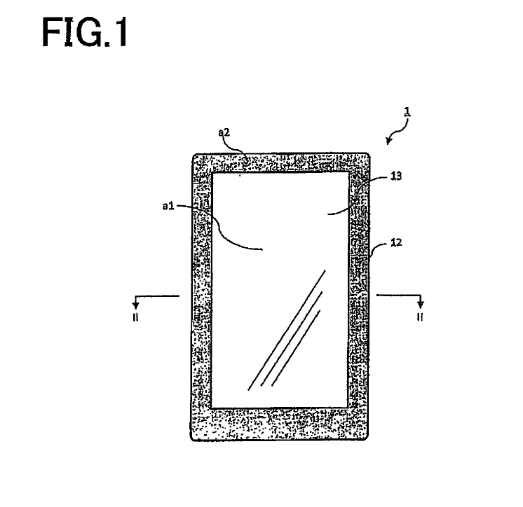

FIG. 1 is a front view showing a basic configuration of a decorative film 1 according to one embodiment of the present invention, where the decorative film 1 of the present embodiment includes a display region al (white portion in FIG. 1), which is a central part where a decorative pattern produced by printing, and the like is not formed, and a decorative region a2 (gray portion in FIG. 1), which is an entire region of the outer peripheral part of the display region al where the decorative pattern is formed.

The decorative region a2 does not need to be the entire region of the outer peripheral part of the display region a1, and may be a discrete separated regions. For example, the decorative film 1 of the present invention also includes a case where one of the sides among the upper side, the lower side, the left side, and the right side is absent with respect to the frame-shaped decorative region a2 shown in FIG. 1, or a case where a part of one of the sides is broken in relation with the device (microphone, speaker, camera, etc.) arranged in the display surface 21 of the display device 2. A specific shape of the display region al and the decorative region a2 can be appropriately set according to the shape of the display surface 21 of the display device 2 to be applied.

The decorative region a2 is a region for decorating the display surface 21 of the display device 2 with various types of patterns through printing, and the like, and is a region corresponding to the peripheral edge region A2 of the display device 2 shown in FIG. 3. The display region al has light transmissivity, and is a region through which the interior can be visually recognized from the exterior and is a region corresponding to the display region Al of the display device 2 shown in FIG. 3.

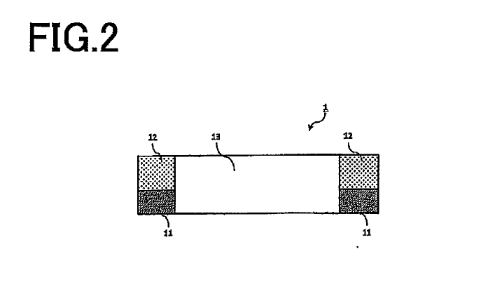

FIG. 2 is a cross-sectional view taken along line II-II of FIG. 1, and the decorative film 1 of the present embodiment includes a base layer 11, a decorative pattern layer 12, and a light transmissive layer 13. The thickness dimension of FIG. 2 is shown in an exaggerated manner to show the configuration of each layer 11, 12, and 13 in an easily understandable manner.

The base layer 11 is an insulating resin base material (film) having a thickness between 2 μm and 300 μm, preferably between 5 and 50 μm, and more preferably between 10 and 25 μm, and PET (polyethylene terephthalate), PC (polycarbonate), PMMA (polymethyl methacrylate/acryl resin), colored film, PET with metal film, and the like can be used. The colored film is a film obtained by mixing pigment or dye to PET, PC, PMMA, or the like. The PET with metal film is a film obtained by adding aluminum, silver, tin, or the like to the PET through vapor deposition method, and the like. PET is desirably used when trying to thin the decorative film 1. Since the base layer 11 essentially contains the insulating resin base material, its adhesiveness with the decorative pattern layer 12 increases. Furthermore, in the decorative film 1 of the present embodiment, the base material (aggregate) made of PET, and the like does not exist other than in the base layer 11 and does not have a configuration in which the base layer and the decorative pattern layer are formed on the base material of PET, and the like. In other words, the light transmissive layer 13 or an attachment layer 14 is directly formed on the surface on the side opposite to the decorative pattern layer 12 of the base layer 11, and the surface on the side opposite to the base layer 11 of the decorative pattern layer 12 without arranging another base material. Therefore, the decorative film 1 itself can be made thin, and hence the light transmissivity also increases. The base material (aggregate) referred to herein does not include any sticky material that is arranged on one surface or both surfaces of the base material as a sticky layer.

When forming the base layer 11 with the colored film, the decorative pattern layer 12 may be omitted, and the decorative pattern may be formed with the colored film itself. Still, when configuring the base layer 11 with the colored film, the decorative pattern layer 12 through printing, and the like may also be further formed on the colored film. Accordingly, various decorations can be realized.

The decorative pattern layer 12 may be formed with pigmented coloring, and the like, where its thickness is between 1 and 30 μm, and is configured by forming the decorative pattern by screen printing, gravure printing, other appropriate printing, sublimation (thermal) transfer, or foil laminating transfer (so-called hot stamp) on one surface (or both surfaces) of the base layer 11. The decorative pattern layer 12 can be formed to have an arbitrary color, such as black, white, pink, and the like, for example. A desired logo, such as a character, number, pattern, and the like can be formed by foil laminating transfer (so-called hot stamp) in an arbitrary region of the decorative pattern layer 12. The decorative pattern layer 12 may be a single layer (i.e., one layer) or a plurality of layers. If the decorative pattern layer 12 does not have a pattern or if the pattern is simple, the decorative pattern layer 12 is preferably assumed as a single layer. If the decorative pattern layer 12 has a plurality of colors or a complex pattern, the decorative pattern layer 12 is preferably assumed as a plurality of layers. The diversification of decoration can be realized by forming the decorative pattern layer 12 into multiple layers.

The decorative pattern layer 12 may be arranged only on one surface of the base layer 11 or may be arranged on both surfaces of the base layer 11. The decoration to add to the display surface of the display device can be diversified by forming the decorative pattern layer 12 on both surfaces of the base layer 11. In this case, the decorative pattern layer 12 arranged on both surfaces of the base layer 11 may have the same property or may have different properties from each other. Thus, diversification of the decoration to add to the display surface of the display device, for example, providing various colors and providing various patterns can be realized. Furthermore, the properties can be modified by changing the material, color, film thickness, and hardness.

The light transmissive layer 13 has a thickness equal to or greater than the sum of the base layer 11 and the decorative pattern layer 12 and between 2 and 300 μm, and may be made of ionizing radiation curing compound that is cured by irradiating the ionizing radiation, specifically, ultraviolet curing compound, electron beam curing compound, and the like are preferred, and the ultraviolet curing compound is particularly preferred. The ionizing radiation curing compound is preferably an unsaturated monomer, oligomer, resin, composition containing the same and the like. As a specific example, a multifunctional ionizing radiation curing acrylic compound having two or more functional groups such as a multifunctional acrylate, urethane acrylate, polyester acrylate, and the like are more preferred, and urethane acrylate and polyester acrylate are particularly preferred. The ionizing radiation includes ultraviolet light, electron beam, a beam, 13 beam, and the like. When using the ultraviolet light, the curable composition preferably contains a photo-polymerization initiator. Such ionizing radiation curing compounds may have a pressure sensitive adhesiveness. With the pressure sensitive adhesiveness provided to the light transmissive layer 13, the attachment layer becomes unnecessary and further thinning can be realized. The material cost can also be reduced. The pressure sensitive adhesiveness is assumed to have a peeling strength greater than or equal to 5N/25 mm in the 180 degrees peeling test with the anti-protective plate in JIS L-6854.

The hardness of the light transmissive layer 13 preferably is a Shore hardness between 5 and 90 HS, and contributes to the anti-scattering of the glass of the display device 2 if it is hard and excels in external impact absorption and level difference absorption effect achieved through the decorative pattern layer 12 if it is soft. If the hardness can be changed between the front surface side of the light transmissive layer 13 (surface not facing the display surface of the display device 2) and the back surface side (surface facing the display surface side of the display device 2), the front surface side is preferably set to be hard and the back surface side is preferably set to be soft.

The light transmissive layer 13 preferably has a transmissivity of greater than or equal to a transmissivity of 80%, and the index of refraction between 1.2 and 1.8. If the transmissivity and the index of refraction of the light transmissive layer 13 are within such range, the difference in the index of refraction with the protective plate, the glass material, which is the display base material, the optical plastic material, and the like, which serve as bodies adhered to the top and bottom, becomes small. Thus, the internal transmitting light becomes difficult to refract, and the adverse effect on the display portion of the display can be prevented.

The decorative film 1 of the present embodiment is an integrated film that includes the light transmissive layer 13 at the central part of the decorative film 1 as shown in the cross-sectional view of FIG. 2, and that includes the base layer 11, which is flush with one main surface (upper side surface in the figure) of the light transmissive layer 13 and the decorative pattern layer 12, which is flush with the other main surface (lower side surface in the figure) of the light transmissive layer 13 on both sides of the outer peripheral part of the light transmissive layer 13. Hence, it is a film that has an excellent flatness in which the level difference from the decorative pattern layer 12 is small. The decorative film 1 of the present embodiment includes the light transmissive layer 13 at the opening of the base layer 11 and the decorative pattern layer 12, and the light transmissive layer 13 is primarily not formed on the base layer 11 in the display surface. Hence, the involvement of air at the display surface can be suppressed. Furthermore, the decorative film 1 can be further thinned by using a thin base layer 11.

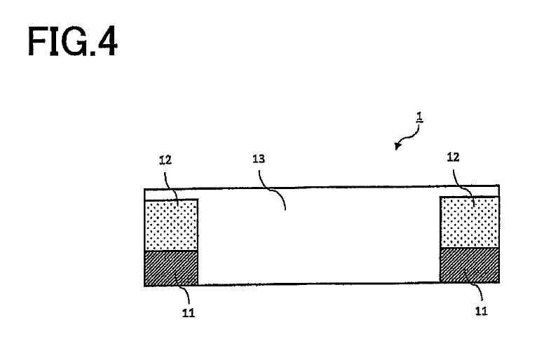

In the embodiment shown in FIG. 2, the upper side surface of the decorative pattern layer 12 and the upper side surface of the light transmissive layer 13 are configured to be flush, and the lower side surface of the base layer 11 and the lower side surface of the light transmissive layer 13 are configured to be flush. However, the outer peripheral part of the upper side surface and the lower side surface of the light transmissive layer 13 may also be configured to cover the surface of the decorative pattern layer 12 and/or the base layer 11 as shown in FIG. 4 to FIG. 6.

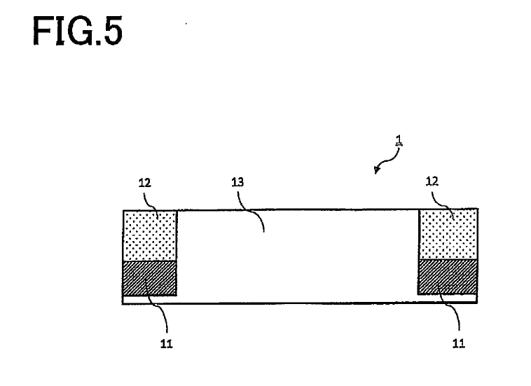

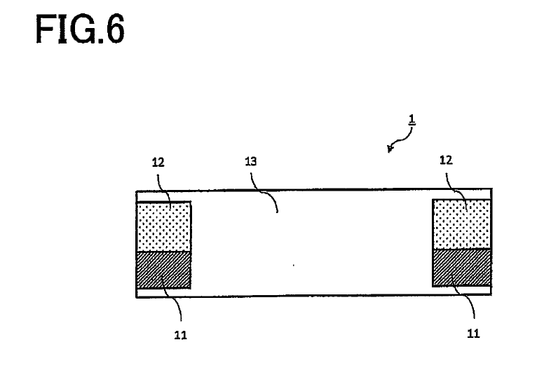

For example, the decorative film 1 shown in FIG. 4 has the outer peripheral part of the upper side surface of the light transmissive layer 13 configured to be flat to cover the entire upper side surface of the decorative pattern layer 12, the decorative film 1 shown in FIG. 5 has the outer peripheral part of the lower side surface of the light transmissive layer 13 configured to be flat to cover the entire lower side surface of the base layer 11, and the decorative film 1 shown in FIG. 6 has the outer peripheral part of the upper side surface of the light transmissive layer 13 configured to be flat to cover the entire upper side surface of the decorative pattern layer 12 and the outer peripheral part of the lower side surface of the light transmissive layer 13 configured to be flat to cover the entire lower side surface of the base layer 11.

With the outer peripheral part of the main surface of the light transmissive layer 13 configured to be flat so as to cover the surface of the decorative pattern layer 12 and/or the base layer 11, an edge can be prevented from occurring at the boundary of the peripheral edge of the light transmissive layer 13 and the inner peripheral edge of the decorative pattern layer 12 or the inner peripheral edge of the base layer 11. Thus, a flatter decorative film can be provided. The adhesion strength increases by the amount of increase in the adhesion area of the light transmissive layer 13 and the base layer 11 or the decorative pattern layer 12. In particular, if the light transmissive layer 13 is made of ultraviolet curable resin and the base layer 11 is made of PET, the ultraviolet curable resin chemically reacts with the surface of the PET when curing, thus further enhancing the adhesion strength.

<<Configuration of Protective Panel>>

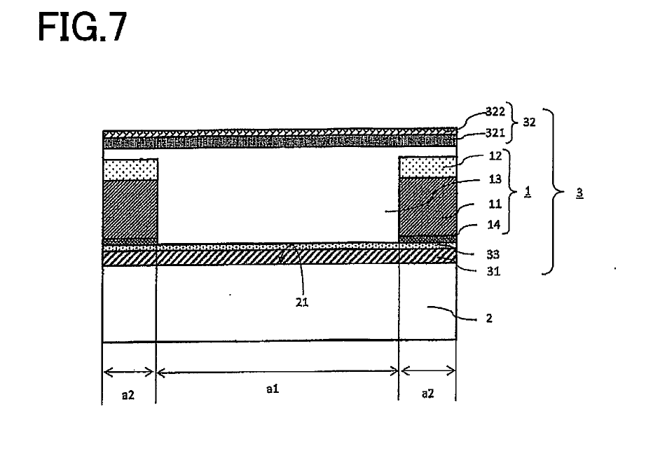

The decorative film 1 of the present embodiment described above can be attached to the display surface 21 of the display device 2 after being combined with the protective plate 31 and the hard coat film 32 thus obtaining a protective panel 3. FIG. 7 is a cross-sectional view showing a state in which one example of the protective panel 3, where the protective plate 31 and the hard coat film 32 are attached to two main surfaces of the decorative film 1 according to the embodiment shown in FIG. 4, is attached to the display surface 21 of the display device 2. In the decorative film 1 of the present embodiment, the attachment layer 14 can be arranged on the surface of the base layer 11 (or the surface of the decorative pattern layer 12). This is convenient in that other arbitrary films, that is, the protective plate 31 and the hard coat film 32 can be easily attached to the decorative film 1 with the attachment layer 14. Although the coupling state of the protective plate 31 and the display device 2 is not illustrated in detail in FIG. 7, they can be completely attached to each other with a coreless tape, or a so-called OCA (Optical Clear Adhesive: optical transparent sticking agent), which is formed merely with a sticking agent and that does not contain a base material, completely attached to each other with an ultraviolet curable resin, or their peripheral portions can be attached to each other in a frame-form with a double-sided tape having a narrow width.

The protective panel 3 including the decorative film 1 has a planar shape corresponding to the display surface 21 of the display device 2 and has a thickness corresponding to the area of such planar shape to protect the display surface 21 of the display device 2. Generally, the planar shape of the protective panel 3 is often formed slightly larger than the display surface 21. The protective panel 3 shown in the cross-sectional view of FIG. 7 includes the protective plate 31, the attachment layer 33, the decorative film 1 (including attachment layer 14), and the hard coat film 32 when seen from the display device 2 side. The coupled body of the hard coat film 32 and the decorative film 1 (in particular, the light transmissive layer 13) functions as an anti-scattering film that prevents broken pieces of the protective plate 31 from scattering to the surrounding even when an excessive impact is applied on the protective panel 3 thus breaking the protective plate 31.

The protective plate 31 may be made of glass, PC, PMMA, PET, and the like, for example, and has a thickness of between 50 and 2000 μm, for example.

The attachment layer 33 may be configured with a one-sided sticky tape or a one-sided adhesion tape, and is formed by forming a transparent sticky layer or a transparent adhesive layer on a transparent film, which serves as a base material film. The transparent film may be made of PET, PC, PMMA, and the like, for example. Furthermore, the transparent sticky layer or the transparent adhesion layer is a coreless tape or a so-called OCA (Optical Clear Adhesive: optical transparent sticking agent) that is formed merely with a sticking agent or an adhesion agent and that does not contain a base material. As the sticking agent or the adhesion agent, for example, acryl series, urethane series, silicone series, rubber series, or polyether series sticking agent or adhesion agent may be used. In FIG. 7, the attachment layer 14 made of acrylic resin, urethane resin, epoxy resin, silicone resin, polyester resin, or the like, for example, is arranged on the lower surface of the base layer 11 to attach the transparent film of the attachment layer 33 to the decorative film 1.

The hard coat film 32 is formed by forming a hard coat layer 322 on a transparent film 321, which serves as a base material film, that is, by hard coat processing one main surface of the transparent film 32, and has a thickness of between 50 and 500 μm, for example. The transparent film 321 by itself that is not performed with the hard coat processing, that is, without the hard coat layer 322 may be used instead of having the hard coat film 32.

The transparent film 321 may be made of PET, PC, PMMA, and other transparent resins, for example. The hard coat layer 322 is formed with urethane acrylate, epoxy acrylate, and silicon acrylate, for example. If the transparent film of the attachment layer 33 (one-sided sticky tape or one-sided adhesion tape) and the transparent film 321 of the hard coat film 32 are made from PET, such films can be thin. Generally, when the film is made from acrylic resin, polycarbonate, and the like, the thickness of such film often exceeds 0.3 mm. When the transparent film is made from PET, the thickness of such film can be set to be smaller than or equal to 0.3 mm, and preferably smaller than or equal to 0.2 mm. The thickness of the entire display device 2 including the protective panel 3 thus can be thinned as the thickness of the films can be thinned.

<<Manufacturing Method of Decorative Film and Protective Panel>>

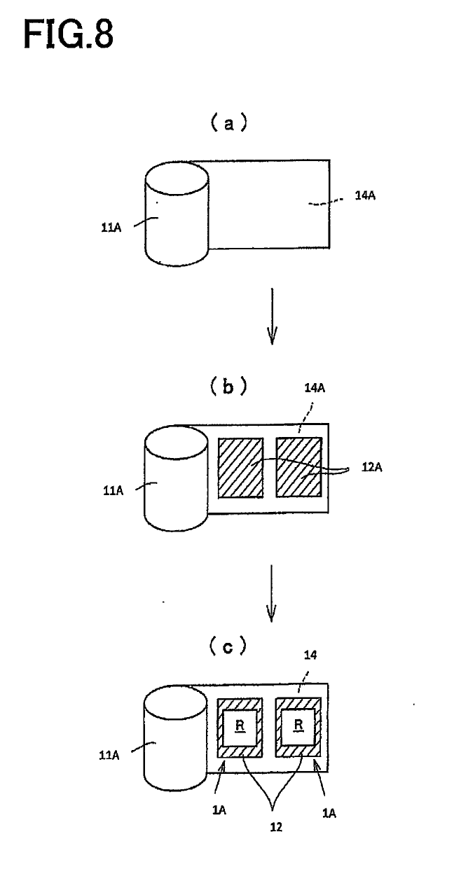

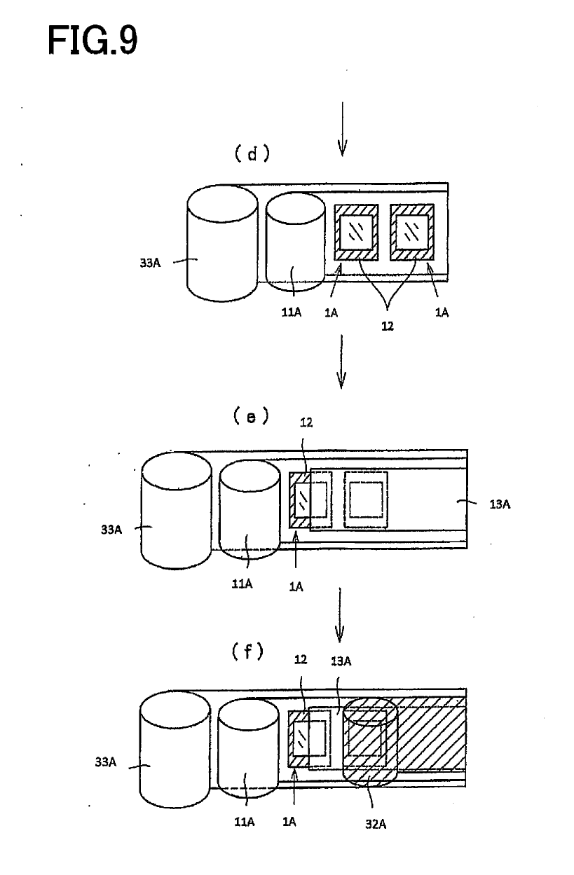

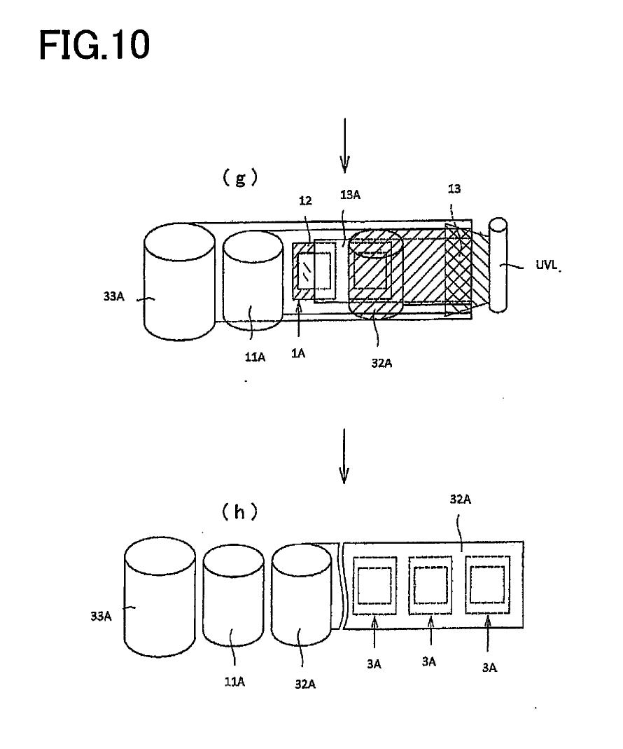

One example of the manufacturing method of the decorative film 1 for the display device and the protective panel 3 for the display device will now be described by way of example, using a case of manufacturing the protective panel 3 for the display device shown in FIG. 7. FIG. 8, FIG. 9, and FIG. 10 schematically show the manufacturing method of the present example in the order of the steps. A series of illustrated steps schematically shows one example of the manufacturing method for each of the decorative film 1 for the display device and the protective panel 3 for the display device according to the present invention, and does not show the manufacturing method in a limiting manner.

First, a base film 11A (indicated with reference numeral 11A as it is the original mode of the base layer 11 shown in FIG. 7) rolled into a long roll form having a constant width is prepared in FIG. 8(a). The base film 11A is a roll-like film and is the raw material forming the base layer 11. On the back surface of the base film 11A (surface on the back side of the plane of drawing of FIG. 8(a)), an attachment layer 14A (indicated with reference numeral 14A as it is the original mode of the attachment layer 14 shown in FIG. 7) is arranged for attaching the base layer 11 of the decorative film 1 of FIG. 7 to the transparent film of the one-sided sticky tape configuring the attachment layer 33.

The base film 11A is then pulled from the winding portion, and the decorative pattern layer 12A (indicated with reference numeral 12A as it is an original mode of the decorative pattern layer 12 shown in FIG. 7) is formed in a predetermined planar shape at a uniform thickness, that is, a solid form as shown in FIG. 8(b). The predetermined planar shape may be the entire one surface of the base film 11A or may be a square shape, a rectangular shape, a circular shape, or other predetermined shapes on the one surface of the base film 11A. In the present embodiment, it is formed in a solid-form into a planar shape substantially the same as the entire planar shape of the display surface 21 of the display device 2 of FIG. 2, that is, a rectangular shape. The method for forming the decorative pattern layer 12A can be an arbitrary known layer forming method such as screen printing method, gravure printing method, and the like, and can be formed with an arbitrary ink of an arbitrary color (e.g., black, white, pink).

A region R of a predetermined area in the decorative pattern layer 12A is removed by punching work using an appropriate tool, for example, a punching blade, as shown in FIG. 8(c) with respect to a printed film after the printing process is finished. The region R corresponding to the display region al of FIG. 1 is thereby removed, thus forming the passed-through opening, and the decorative pattern layer 12 serving as the desired pattern, that is, the decorative pattern having a rectangular frame shape is formed at the same time. The passed-through opening passes through the decorative pattern layer 12A and also passes through the base film 11A and the attachment layer 14A. An intermediate body 1A of the decorative film 1 including the base layer 11, the decorative pattern layer 12, and the attachment layer 14 as shown in FIG. 7 is thereby formed. A method for forming the passed-through opening of the present example may also include laser processing and other known cutting work methods, in addition to the method with the punching work using the punching blade.

Next, as shown in FIG. 9(d), a one-sided sticky tape 33A wound in a roll form (indicated with a reference numeral 33A as it is an original mode of the attachment layer 33 shown in FIG. 7) is pulled out from the roll state into the film state, and is adhered to the back surface of the decorative film 1 with the attachment layer 14 of the decorative film 1. In this case, a separator is attached to the outer side surface of the transparent stick layer of the one-sided sticky tape 33A. Furthermore, as shown in FIG. 9(e), the ionizing radiation curing compound, for example, the ultraviolet curable resin 13A (indicated with a reference numeral 13A as it is an original mode of the light transmissive layer 13 shown in FIG. 7) in a fluid form is applied on the base film 11A so as to cover the decorative pattern layer 12.

In FIG. 9(f), the hard coat film 32A (indicated with a reference numeral 32A as it is an original mode of the hard coat film 32 shown in FIG. 7) wound in a roll form is pulled out from the roll state into the film state and placed on the ultraviolet curable resin 13A. In FIG. 10(g), the ultraviolet light radiated from an ultraviolet lamp UVL is irradiated on the ultraviolet curable resin 13A through the hard coat film 32A to cure the resin 13A. The light transmissive layer 13 shown in FIG. 7 is formed by curing the ultraviolet curable resin 13A, and at the same time, the transparent film 321 of the hard coat film 32 is adhered to the decorative film 1.

As a result, a long film body is formed in which a plurality of protective panels 3A for the display device (indicated with a reference numeral 3A as it is an original mode not including the protective plate 31) is formed in a series, as shown in FIG. 10(h). The portion of the individual protective panel 3A is cut from the film body so that the protective panel 3A for the display device serving as a product is individually formed. The long film body including the plurality of protective panels 3A for the display device arranged in the series may be wound into a roll form. The individually formed protective panel 3A is attached to the protective plate 31 of the display surface 21 of the display device 2 shown in FIG. 7, so that the protective panel 3 including the protective plate 31 is formed on the display surface 21.

Therefore, according to the manufacturing method of the present example, a great number of protective panels 3 for the display device having the configuration shown in FIG. 7 can be stably and accurately manufactured. According to the protective panel 3 for the display device 2, the ionizing radiation curing compound 13A is filled between the attachment layer (one-sided sticky tape) 33 and the hard coat film 32, and is irradiated with ionizing radiation and cured to form the light transmissive layer 13, so that even if a projecting portion is resulted when the decorative pattern layer 12 is placed on the base layer 11, such portion is buried by the light transmissive layer 13, thus preventing the formation of a level difference.

Conventionally, the decorative region a2, which is the peripheral edge region, is patterned by screen printing and the like on the base layer 11A. In the screen printing, a photosensitive film is arranged in a screen block of the portion corresponding to the display region al of the protective panel 3 in FIG. 7, and the peripheral edge line of the display region al, that is, the inner peripheral edge line of the peripheral edge region a2 is defined by the outer edge line of the photosensitive film. If the screen block is a new one, the inner peripheral edge line of the decorative pattern layer 12 forming the peripheral edge region a2 can be formed into a clear and definite line. However, the photosensitive film in the screen block degrades when the manufacturing of the protective panel 3 is repeatedly carried out, and hence print bleeding (i.e., print blur) occurs at the inner peripheral edge line, that is, the boundary line portion of the printing pattern. As a result, the inner peripheral edge line turns into a nonlinear, disturbed state instead of a clear line form, and consequently, the appearance of the inner peripheral edge portion of the formed decorative pattern layer 12 is greatly impaired. To prevent this, the screen block needs to be frequently replaced, which as a result, results in a problem that the manufacturing cost becomes very high.

However, in the manufacturing method of the present embodiment, the decorative pattern layer 12 is formed into a desired shape by cutting work such as the punching work, and the like, instead of screen printing using the screen block. Thus, the inner peripheral edge of the decorative pattern layer 12 is always a clear continuing line, and the boundary line of the display region al and the peripheral edge region a2, which is the non-display region, is clearly formed with such inner peripheral edge. If the manufacturing task of the plurality of protective panels 3 is repeatedly carried out for a long period of time by adopting the cutting work such as the punching work, and the like, there is no need to frequently replace components such as the screen block, and the like, and the decorative pattern layer 12 having a clear shape without print blur can be formed over a long period of time. The manufacturing cost thus can be suppressed, and hence a high quality decorative film 1 and protective panel 3 can be manufactured inexpensively.

### <<Other Embodiments of Protective Panel>>

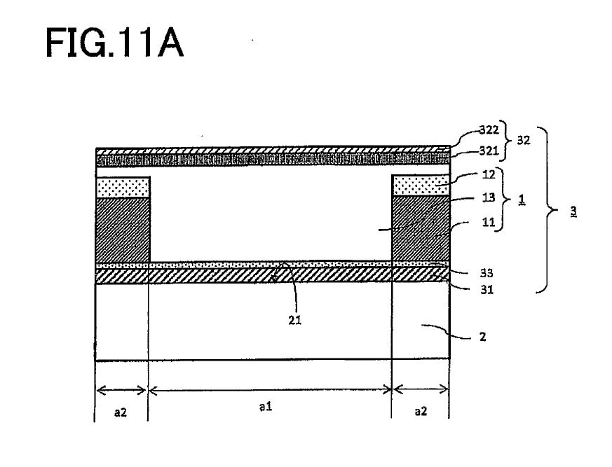

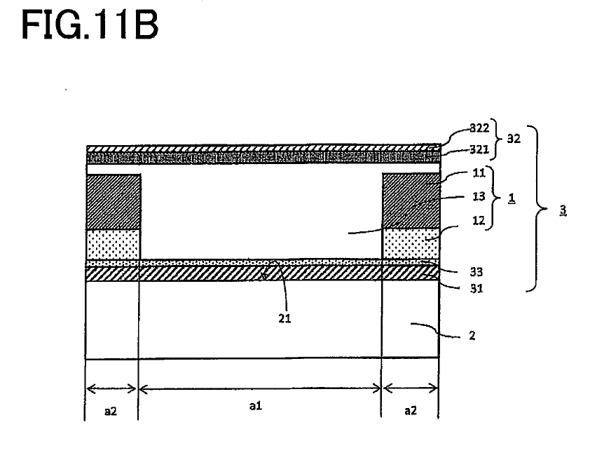

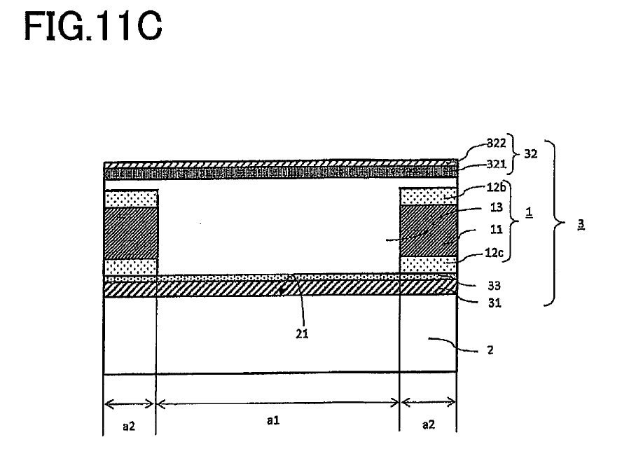

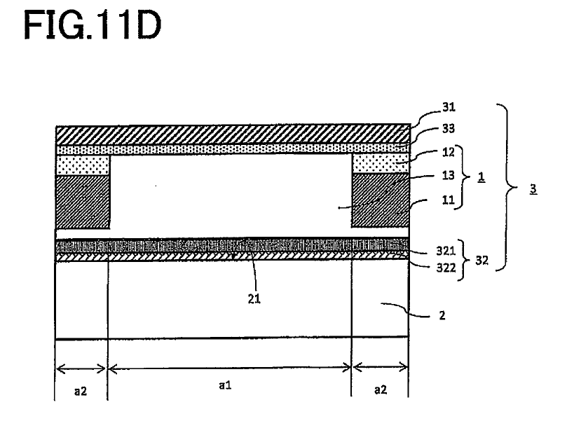

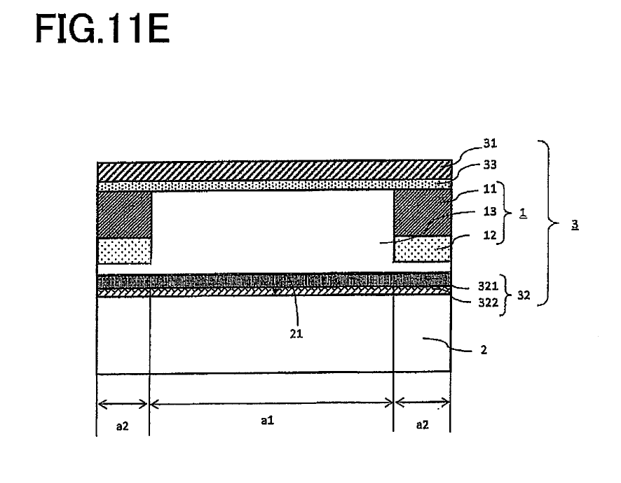

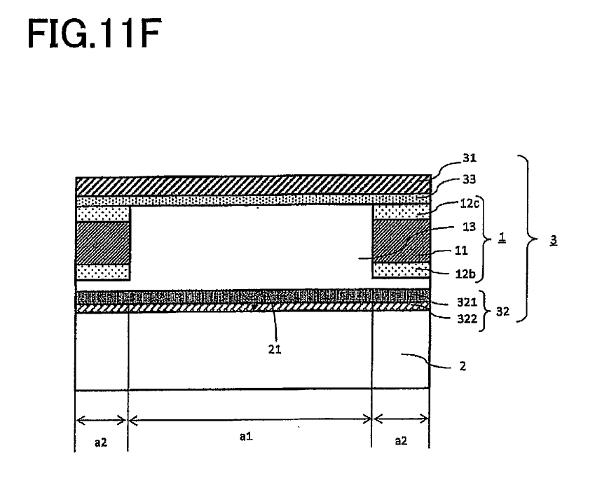

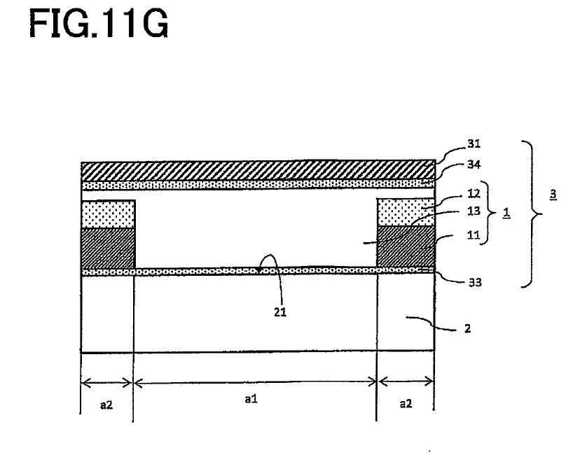

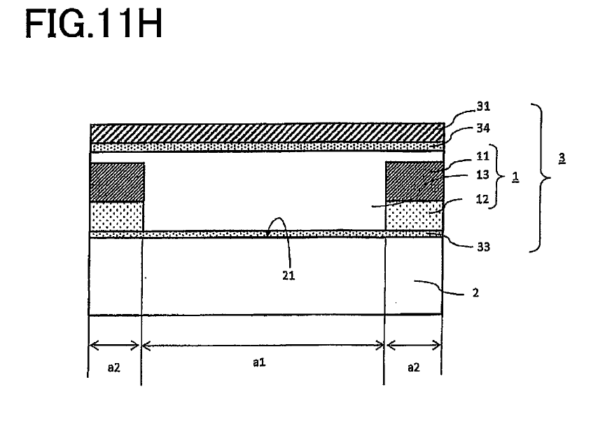

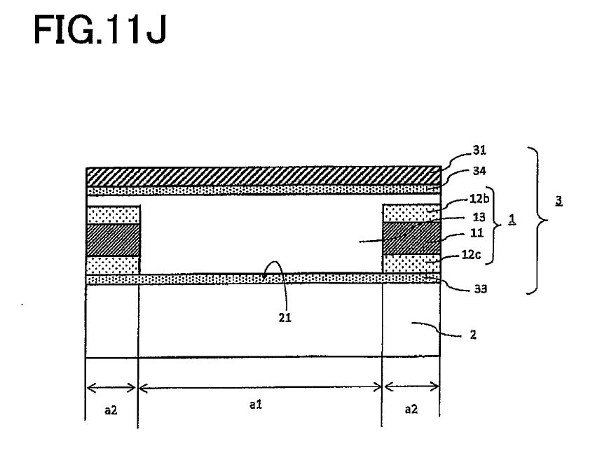

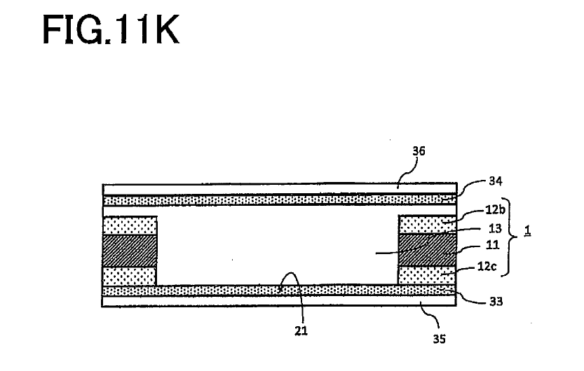

Hereinafter, other embodiments of the protective panel 3 including the decorative film 1 according to the present invention will be described with reference to FIG. 11A to FIG. 11L. In the following embodiment, the same reference numerals are denoted on the members same as the members of the first embodiment shown in FIGS. 1 to 10. The configuration, material, and effect (i.e., function) of such members are the same as those in the first embodiment shown in FIGS. 1 to 10, and hence the same description is applicable in each embodiment and the description will be omitted to avoid redundant description. Only the configuration different from the first embodiment and the specific effects obtained thereby will be described.

FIG. 11A shows a second embodiment of the decorative film 1 for the display device and the protective panel 2 for the display device according to the present invention. In the present embodiment, similar to the embodiment shown in FIG. 1, the protective plate 31 is arranged on the display surface 21 of the display device 2, the decorative film 1 is arranged on the protective plate 31, the hard coat film 32 is arranged on the decorative film 1 at the surface position of the protective panel 3, and the light transmissive layer 13 containing the ionizing radiation curing compound such as the ultraviolet curable resin, and the like is arranged at the central part of the decorative film 1 between the protective plate 31 (more specifically, the attachment layer 33) and the hard coat film 32.

In the present embodiment as well, the decorative pattern layer 12 of the decorative film 1 is not formed directly on the respective surfaces of the hard coat film 32 and the protective plate 31 by printing, and the like, but is formed on the base layer 11 through printing and other appropriate methods to configure the decorative film 1. The decorative pattern layer 12 serving as the decorative pattern is arranged on the hard coat film 32, the protective plate 31, and the like in the form of the decorative film 1.

The present embodiment differs from the first embodiment shown in FIG. 7 in that the decorative film 1 does not include the attachment layer 14, and the decorative film 1 is adhered to the protective plate 31 by the adhesion layer 33 not including the sticky tape. According to such configuration as well, the effects similar to the first embodiment are obtained.

FIG. 11B shows a third embodiment of the decorative film 1 for the display device and the protective panel 3 for the display device according to the present invention. This embodiment has a configuration in which the decorative pattern layer 12 serving as the decorative pattern and the base layer 11 configuring the decorative film 1 are turned upside down compared to the embodiment shown in FIG. 11A. In other words, the decorative pattern layer 12 is on the protective plate 31 side, and the base layer 11 is on the hard coat film 32 side. According to such configuration as well, effects similar to the first embodiment are obtained.

FIG. 11C shows a fourth embodiment of the decorative film 1 for the display device and the protective panel 3 for the display device according to the present invention. This embodiment has a configuration in which a decorative pattern layer 12b and a decorative pattern layer 12c are respectively arranged on the front and back two surfaces (both upper and lower surfaces of FIG. 11C) of the baser layer 11. According to such configuration, effects similar to the first embodiment are obtained, and in addition, the mode of decoration by decorating can be diversified by forming various patterns on the decorative pattern layers 12b and 12c.

FIG. 11D shows a fifth embodiment of the decorative film 1 for the display device and the protective panel 3 for the display device according to the present invention. The present embodiment differs from the embodiment shown in FIG. 7, and the hard coat film 32 is arranged on the display surface 21 of the display device 2, the decorative film 1 is arranged on the hard coat film 32, and the protective plate 31 is arranged on the decorative film 1 at the surface position of the protective panel 3.

That is, in the present embodiment, the protective plate 31 is arranged on the surface side of the protective panel 3, and the hard coat film 32 is arranged between the protective plate 31 and the display device 2. According to such configuration as well, effects similar to the first embodiment are obtained. In the present embodiment as well, the transparent film 321 by itself that is not subjected to hard coat processing (i.e., not including the hard coat layer) may be used in place of the hard coat film 32.

FIG. 11E shows a sixth embodiment of the decorative film 1 for the display device and the protective panel 3 for the display device according to the present invention. This embodiment has a configuration in which the decorative pattern layer 12 and the baser layer 11 of the decorative film 1 are turned upside down compared to the embodiment shown in FIG. 11D. In other words, the decorative pattern layer 12 is on the protective plate 31 side and the base layer 11 is on the hard coat film 32 side in the embodiment of FIG. 11D, whereas the decorative pattern layer 12 is on the hard coat film 32 side and the base layer 11 is on the protective plate 31 side in the present embodiment. According to such configuration as well, effects similar to the first embodiment are obtained.

FIG. 11F shows a seventh embodiment of the decorative film 1 for the display device and the protective panel 3 for the display device according to the present invention. This embodiment has a configuration in which the decorative pattern layer 12b and the decorative pattern layer 12c are arranged respectively on the front and back two surfaces of the base layer 11. According to such configuration as well, effects similar to the first embodiment are obtained, and in addition, the mode of decoration by decorating can be diversified by forming various patterns on the decorative pattern layers 12b and 12c.

FIG. 11G shows an eighth embodiment of the decorative film 1 for the display device and the protective panel 3 for the display device according to the present invention. The present embodiment greatly differs from the previous embodiments in that the hard coat film 32 (see FIG. 7) is not used. The protective panel 3 of the present embodiment is formed, for example, by forming the decorative film 1, attaching the attachment layer 33 to the decorative film 1, applying the ultraviolet curable resin on the decorative film 1, irradiating the ultraviolet light to cure the ultraviolet curable resin and form the light transmissive layer 13, and adhering the protective plate 31 to the light transmissive layer 13 with the attachment layer 34. According to such configuration as well, effects similar to the first embodiment are obtained. The attachment layer 34 may be any one of sticky material, adhesion material, one-sided sticky tape, or one-sided adhesion tape.

FIG. 11H shows a ninth embodiment of the decorative film 1 for the display device and the protective panel 3 for the display device according to the present invention. This embodiment has a configuration in which the decorative pattern layer 12 and the base layer 11 of the decorative film 1 are turned upside down compared to the embodiment shown in FIG. 11G. In other words, the decorative pattern layer 12 is on the protective plate 31 side and the base layer 11 is on the display device 2 side in the embodiment of FIG. 11G, whereas the decorative pattern layer 12 is on the display device 2 side and the base layer 11 is on the protective plate 31 side in the present embodiment. According to such configuration as well, effects similar to the first embodiment are obtained.

FIG. 11J shows a tenth embodiment of the decorative film 1 for the display device and the protective panel 3 for the display device according to the present invention. This embodiment has a configuration in which the decorative pattern layer 12b and the decorative pattern layer 12c are arranged respectively on the front and back two surfaces of the base layer 11. According to such configuration as well, effects similar to the first embodiment are obtained, and in addition, the mode of decoration by decorating0 can be diversified by forming various patterns on the decorative pattern layers 12b and 12c.

FIG. 11K is a main cross-sectional view showing a state (packing style) before the decorative film 1 for the display device according to the present invention is attached to the display surface 21 of the display device 2. When transporting in the state of the decorative film 1, a state in which peeling sheets 35, 36 are attached to the respective sticky layers 33, 34 is desired.

### DESCRIPTION OF REFERENCE SIGNS

1 Decorative film

11 Base layer

12 Decorative pattern layer

13 Light transmissive layer

a1 Display region

a2 Decorative region

2 Display device

21 Display surface

A1 Image display region

A2 Peripheral edge region (frame region)

3 Protective panel

31 Protective plate

32 Hard coat film

321 Transparent film

322 Hard coat layer

33, 34 Attachment layer

35, 36 Peeling sheet

1. A decorative film for a display device that is directly or indirectly arranged on a display surface of the display device, and that includes a display region, which is a central part of the decorative film, having light transmissivity through which the display surface is visually recognized from outside, and a decorative region, which is an outer peripheral part around the display region, for decorating the display surface, the decorative film comprising:
a base layer containing a film and arranged in the decorative region;
a decorative pattern layer formed on a main surface of the base layer; and
a light transmissive layer arranged in at least a space surrounded by the base layer and the decorative pattern layer in the display region.

2. The decorative film for the display device according to claim 1, wherein the light transmissive layer is arranged in an extended manner on a main surface of the decorative pattern layer on a side opposite to the base layer.

3. The decorative film for the display device according to claim 1, wherein the light transmissive layer is arranged in an extended manner on a main surface of the base layer on a side opposite to the decorative pattern layer.

4. The decorative film for the display device according to claim 1, wherein the base layer is a colored layer.

5. The decorative film for the display device according to claim 1, wherein the light transmissive layer has a transmissivity of greater than or equal to 80%.

6. The decorative film for the display device according to claim 1, further comprising an attachment layer arranged on at least one main surface.

7. The decorative film for the display device according to claim 1, wherein boundary surfaces of the base layer and the light transmissive layer are formed flush, and boundary surfaces of the decorative pattern layer and the light transmissive layer are formed flush in the cross-sectional view of the decorative film.

8. The decorative film for the display device according to claim 1, wherein the decorative pattern layer is formed with multiple layers.

9. The decorative film for the display device according to claim 1, wherein the decorative pattern layer is arranged on both main surfaces of the base layer.

10. The decorative film for the display device according to claim 1, wherein the light transmissive layer is made of acrylic compound.

11. The decorative film for the display device according to claim 1, wherein the light transmissive layer is divided into a plurality of layers in a thickness direction, and the respective hardness of the plurality of layers are different from each other.

12. The decorative film for the display device according to claim 1, further comprising a peeling sheet is arranged on at least one main surface.

13. A protective panel for a display device arranged on a display surface of the display device, the protective panel comprising:
a decorative film according to claim 1, and
a protective plate that covers the display surface;
the decorative film being arranged between the display surface and the protective plate, or faces the display surface with the protective plate sandwiched in between.

14. The protective panel for the display device according to claim 13, wherein the decorative film and the protective plate are directly attached to each other by an adhesion material, a sticky material, an adhesion tape, or a sticky tape.

15. The protective panel for the display device according to claim 13, further comprising a hard coat film or a transparent film arranged on a side of the decorative film opposite to the surface attached with the protective plate.
